(19) United States
(12) Patent Application Publication
(10) Pub. No.: US 2005/0218565 A1
(43) Pub. Date: Oct. 6, 2005

(54) Oxide based ceramic matrix composites

(76) Inventor: Robert A. DiChiara JR., Carlsbad, CA (US)

Correspondence Address: HARNESS, DICKEY & PIERCE, P.L.C., P.O. BOX 828, BLOOMFIELD HILLS, MI, 48303, US

(21) Appl. No.: 11/134,876

(22) Filed: May 23, 2005

Related U.S. Application Data
(62) Division of application No. 09/918,158, filed on Jul. 30, 2001.

(51) Int. Cl. C04B 35/00

(52) U.S. Cl. 264/621

(57) ABSTRACT

A method of making a ceramic matrix composites (CMC) having superior properties at high temperatures. The CMC can include a sol gel mixture mixed or blended metal oxide particles. The sol-gel mixture can be an aqueous colloidal suspension of a metal oxide, preferably from about 10 wt % to about 25 wt % of the metal oxide, containing a metal oxide such as alumina (Al₂O₃), silica (SiO₂) or alumina-coated silica. The mixture can be infiltrated into a ceramic fiber, gelled, dried and sintered to form the CMC of the present teachings.

### CROSS-REFERENCE TO RELATED APPLICATIONS

This application is a divisional of U.S. patent application Ser. No. 09/918,158 filed on Jul. 30, 2001. The disclosure of the above application is incorporated herein by reference.

### FIELD

The present teachings generally relate to ceramic matrix composites and particularly to oxide-based ceramic matrix composites comprising sol gel and the processes for making such composites.

### BACKGROUND

Ceramic Matrix Composite (CMC) is an emerging material well suited to high temperature structural environments for aerospace and industrial applications. Advanced structural ceramics are materials that have relatively high mechanical strength at high temperatures. These materials face a number of physically demanding conditions such as high temperature, corrosive conditions, and high acoustic environments.

The oxide based ceramic matrix composites (CMC) developed are economic, low dielectric, thermally stable, structural ceramic systems stable to at least 2300° F. The matrix is reinforceable with a variety of fibers (Quartz, Nextel 312, 550, 610, 650, 720). Preferably the fiber is, but not limited to, Nextel 720. The CMC's primary advantage over carbon-carbon and other high temperature composites is its low cost and near net-shape manufacturing process.

Prior to 1980 ceramics were considered monolithic, being made of one material. The advantages of monolithic ceramics is that the ceramic properties such as high strength, wear resistance, hardness, stiffness, corrosion resistance, thermal expansion and density can be varied depending on the starting materials. However the density of the monolithic ceramics are significantly lower (0.08-0.14 lb/in³) compared to metallic counterparts (generally >0.3 lb/in³). Also, these ceramics are not ductile like metal, and instead may shatter, crack or crumble under applied stress and/or strain. Therefore, physical properties prevented designers from considering ceramics in many structural applications.

In the mid-1980s a revolution in the field of ceramics occurred with the development of new ceramic fibers (from Nippon Carbon and 3M) and the development of the Chemical Vapor Infiltration process (CVI). Fibers added to a ceramic matrix produce a fiber-reinforced ceramic, which increases the ceramic strength and toughness and eliminates or reduces the likelihood of poor operational results at high temperatures. Each unique type of fiber added to the ceramic mix provides unique properties to the material. The exploration of fiber types and resulting properties led to numerous combinations uniquely tailored to specific ceramic applications. These ceramics are known as ceramic matrix composite (CMC) or continuous-fiber-reinforced ceramic composites (CFCC) which distinguish them from chopped fiber reinforced ceramics.

The key to the strength and toughness of a CMC system is to maintain a limited amount of fiber matrix bonding. This is difficult to achieve considering the amount of thermal energy that is being applied to the surface chemistry of the matrix and fiber surface. Success exists in four basic types of ceramic matrix systems: (1) Chemical vapor infiltration (CVI), (2) glass ceramics, (3) organo-metallic derived from polymer precursors, and (4) oxide matrix ceramics.

As discussed above, CMC produced using the CVI process overcomes the drawbacks of monolithic ceramics. However, major drawbacks of infiltrating the fabric using the CVI process are the expense and time required to produce parts, which in particular instances, requires months. Further, the process is labor and capital intensive, and limited with respect to the size and shape of parts that can be produced.

More recently, a number of CMC organic-metallic processes have been developed. These processes follow the same standard processing procedures and equipment developed for making organic composites, thereby eliminating many of the slow and costly limitations that were found with the CVI process. In the CMC processes ceramic fibers are first made and woven into cloths, such as fiberglass or carbon fiber for organic composites. The flexible ceramic cloth is then infiltrated with an organic-metallic matrix such as an epoxy matrix for organic composites. This impregnated cloth is then placed on a complex tool and processed under low pressure and low temperature in a process known as autoclaving. After autoclaving, a complex shaped ceramic structure is formed and then further heated in a furnace to finish the process.

Glass ceramic CMC formation typically begins with a glass powder, often formulated with silicates that are thermoplastically formed along with reinforcing fibers at very high temperatures and pressures. The fibers require protection with fiber interface coatings such as boron nitride (BN) in order to control fiber matrix interface. The glass ceramic CMC is subjected to a free standing post cure to crystallize the matrix. Fiber interface coatings are susceptible to oxidation well below 1800° F. However, in a high-densified system such as this, the fiber coatings are protected from the oxidizing environment. High strengths are achievable with flat panels, however the inability to manufacture complex shapes greatly restricts the application glass ceramics.

Organo-metallic ceramics derived from polymer precursors are analogous to carbon-carbon ceramic matrices. A polymer composite is fabricated and then pyrolized to a ceramic. The volume loss during pyrolysis must be reinfiltrated with resin and pyrolized again. This process may be repeated up to ten times in order to achieve the densification necessary to provide oxidation protection to fiber coatings. The most common organo-metallic systems are Polysiazane and Blackglas (Allied Signal). Silicon carbide (SiC) fibers such as Nicalon by Dow Corning are most commonly used with this system, along with fiber coating such as boron nitride (BN). The disadvantages to this system are the high cost, high dielectric constant and the susceptibility of the BN coatings to oxidation. The non-oxide CMC systems require the BN interface with a dense matrix. High strengths are achievable, but the limitation of the material lies in the stress at which the matrix begins to crack (typically about 10 ksi) and also when the BN fiber interface coating begins to oxidize. Stress cracking also becomes evident during cyclical loading of the material.

In recent years, efforts have been made to manufacture oxide matrix ceramics capable of withstanding temperatures greater than 2000° F. One such matrix developed was the aluminum phosphate bonded alumina oxide CMC. Fiber reinforcement was primary Nicalon 8 harness satin fabric. However, studies of the matrix found repetitive cycles in excess of 1500° F. caused phase inversions in the matrix limiting use of the material to a temperature no greater than 1400° F.

### SUMMARY

The present teachings provide ceramic matrix composites (CMC) having superior properties at high temperatures. In one embodiment, the CMC comprises or is formed in part from a sol gel matrix or mixture with alumina powder mixed or blended into the matrix. The sol-gel matrix is an aqueous colloidal suspension of a metal oxide, preferably composed of particles in the size range of 4-150 nanometers and concentrations from about 10 wt % to about 25 wt % of the metal oxide. Preferably the metal oxide is alumina (Al₂O₃), silica (SiO₂) or alumina-coated silica.

Methods for making the CMC of the present teachings are also provided. The methods of the present teachings comprise providing a sol-gel mixture and mixing or blending alumina powder into the mixture. The alumina powder preferably comprises from about 30 wt % to about 60 wt % of the blended mixture. In various embodiments, the alumina powder that is mixed into the sol has a size less than or equal to about 1.5 microns and preferably from about 0.1 microns to about 1.0 microns. If necessary, the pH of the mixture is adjusted to prevent gelling by adding acid or base to the mixture. The sol-gel mixture is then ball milled or high shear mixed to remove any soft agglomerates that form, producing a homogeneous suspension. In a further embodiment, this homogeneous solution is then infiltrated using a doctor blade casting set up into a suitable ceramic cloth or fabric. Layers of infiltrated fabrics are laid up and placed in a vacuum bag, cured with or without pressure from a press or autoclave, then de-bagged and fired.

In another embodiment, complex parts can be manufactured using the CMC of the present teachings in a similar processing procedure for organic composites. Layers of infiltrated fabric are slightly dried to develop tack, draped over the desired tool form, then subjected to a vacuum bag cure and/or autoclave cured to 350° F. The tool form is then removed and the part is post cured at a temperature from about 1000° F. to about 2300° F., preferably 2000° F.

One of the objects of the present teachings is to manufacture a ceramic matrix that can withstand high temperature and has a high strength including porosity for toughness. It is another object of the present teachings to manufacture a ceramic matrix composite that is alcohol, or preferably, water based.

Further areas of applicability of the present teachings will become apparent from the detailed description provided hereinafter. It should be understood that the detailed description and examples are intended for purposes of illustration only, since various changes and modifications within the spirit and scope of the teachings will become apparent to those skilled in the art from this detailed description.

### DETAILED DESCRIPTION OF VARIOUS EMBODIMENTS

In accordance with the broad teachings, a ceramic matrix composite is manufactured using a sol gel matrix mixture comprising a sol-gel matrix and alumina powder. The mixture can also contain polymers (acrylic polymers) to improve processing, but the polymer is not necessary. The mixture is then infiltrated into a suitable ceramic cloth or fabric to obtain a fiber reinforced ceramic matrix composite (CMC) that is suitable for manufacturing a number of complex shape tools.

In one embodiment, the ceramic matrix composition comprises or is formed in part from a sol-gel and alumina powder. In various embodiments, the sol-gel is from about 40 wt % to about 70 wt % of the sol-gel and alumina mixture. Sol-gel is a material that can be used for making advanced materials including ceramics. There are two phases to the material, a liquid “sol”, which is a colloidal suspension, and a solid “gel” phase. The transition from the liquid sol phase to the solid gel phase can be triggered by drying, heat treatment or increasing the pH to the basic range. The starting materials used in the preparation of the sol-gel are usually inorganic metal salts or metal organic compounds such as metal alkoxides. According to various embodiments, the sol-gel comprises metal oxides, preferably alumina (Al₂O₃), silica (SiO₂) or alumina-coated silica and more preferably, alumina. In various embodiments, the sol-gel comprises from about 10 wt % to about 25 wt % of the metal oxide. Sol-gels are commercially available (from Nalco Chemical or Vista Chemical Company) or can be made by methods known to those skilled in the art.

In another embodiment, the ceramic matrix composite comprises alumina powder blended with or mixed into the sol gel to produce a sol-gel and alumina mixture. In various embodiments, the alumina is from about 30 wt % to about 60 wt % of the mixture. In various embodiments, the alumina powder particles have a size of less than 1.5 microns. Preferably the alumina powder particles have a size less than 1 micron and more preferably from about 0.1 microns to about 1.5 microns. A smaller particle size will result in better infiltration of the sol-gel and alumina powder mixture into a ceramic cloth or fabric to form a CMC. Another advantage of a smaller particle size is improved bonding and sintering of the CMC. The fine particles bond at just 350° F. allowing for the fabrication of complex shaped parts using low cost tooling, at which point the parts are rigid and tooling can be removed. Parts can then be fired tool free from 1000° F. to 2300° F., inclusive. This low firing or sintering temperature also does little damage to fiber in the CMC, providing maximum composite strength.

According to various embodiments, the mixture composition determines the CMC properties. An increasing ratio (by weight) of alumina to silica provides a CMC with superior high temperature refractory properties. For example, a mixture having 100% alumina will have the best refractory properties. However, the addition of silica provides the CMC with additional strength. Therefore, in various embodiments, the amount of silica in the sol-gel and alumina mixture is from about 0 wt % to about 10 wt %. In various embodiments, silica comprises no more than approximately one third of the sol-gel mixture. When silica is mixed with alumina sol it is preferred to use the alumina coated silica sol since the pH of the two sols are similar and premature gelling of the two sols is prevented.

The present teachings also provide a method for producing a complex matrix composite, comprising the steps of blending or mixing alumina powder into a sol-gel mixture, treating the mixture to produce a homogeneous suspension and infiltrating a ceramic cloth or fabric with the sol-gel and alumina mixture. In one embodiment, alumina powder is blended with or mixed into the sol-gel mixture. Preferably the amount of alumina is from about 30 wt % to about 60 wt %. The addition of alumina powder to the sol-gel matrix results in a mixture that is highly loaded with solids and yet has low viscosity.

In another embodiment, the pH of the sol-gel mixture is adjusted to neutral pH, if necessary. For example, addition of the alumina to the sol-gel mixture can result in a mixture that is more alkaline. This change in pH may trigger the undesired transition between the liquid “sol” into the solid “gel”. To prevent this, acid may be added to balance the pH of the mixture. In various embodiments, the amount of acid added to the mixture is from about 0.1 wt % to about 0.3 wt % and more preferably about 0.1 wt %. Suitable acids include, but are not limited to, nitric acid, hydrochloric acid, acidic acid or sulfuric acid.

In a further embodiment, the sol-gel and alumina mixture is treated to produce a homogeneous suspension. The mixture may have soft agglomerates formed from agglomeration of the powder present as a suspension that may interfere with the infiltration of the mixture into the ceramic fabric. Methods for creating a homogeneous suspension are well known in the art. Non-limiting examples include ball milling, attritor milling, and high-shear mixing. In various embodiments, the mixture is ball milled with alumina media. More preferably, the mixture is ball milled for four hours to produce a homogeneous suspension. The resulting material produced after the ball milling process is a homogeneous suspension and smooth slurry having no agglomeration of particles.

The resulting sol-gel and alumina mixture slurry is then infiltrated into a ceramic cloth or fabric using any of the commonly used infiltrating methods. Non-limiting examples of ceramic fabrics of 8 harness satin or plan weave are Nextel 720, Nextel 610, Nextel 550, Nextel 312, Nicalon (SiC), Altex or Almax. Preferably the mixture is infiltrated using a doctor blade or a pinched roller set up. Both of these methods ensure complete infiltration of the mixture into the fiber to form a reinforced matrix. The reinforced matrix is slightly dried to develop a tack and then draped on the desired complex tool shapes. The tool and the infiltrated fabric is vacuum bagged and heated to 350° F. Heating to cure and rigidify the part is done in a vacuum bag with or without pressure (between 30-100 psi) from a press or an autoclave. The use of an autoclave is preferred using 100 psi. During heating the sol mixture starts to gel and the volatile components are removed. The sol-gel and alumina mixture bonds the alumina powder and the ceramic fiber assembly at just 350° F. The parameters of gelling and drying steps are dependent upon many factors including the dimensions of the tool. In a further embodiment, the steps of infiltrating, gelling and drying can be repeated to achieve the desired density of the CMC.

In another embodiment, the tools are removed after 350° F cure and then dried, so the infiltrated fabric retains the desired shape. The infiltrated fabric is then densified fully by sintering it at approximately 2000° F. while free standing without tools. Sintering involves heating the infiltrated fabric to react the dried sol-gel with alumina powder mixture. This gives the CMC load bearing strength.

The foregoing and other aspects of the teachings may be better understood in connection with the following examples, which are presented for purposes of illustration and not by way of limitation.

### EXAMPLE 1

### 100% Alumina Ceramic Matrix

Alumina Sol (14N-4-25, Vista Chemicals) containing 25% solids of colloidal alumina (Al₂O₃) in water was mixed in a blender with submicron alumina powder (SM-8, Baikowski). The mixture contained 57 wt % of alumina sol and 43 wt % of alumina powder. Several drops of nitric acid (about 0.1%) were added to the mixture to balance the pH. The matrix was then ball milled with alumina media for 4 hours before infiltrating into the fabric.

The mixture was infiltrated into the fabric using a doctor blade or a pinched roller set up. This allowed the mixture to fully infiltrate into the fabric. After fabric infiltration, the matrix was slightly dried to develop tack. The material was then draped on complex tools, vacuum bagged having standard bleeders and breathers used in the organic composite industry and autoclaved to 350° F. After exposing the matrix to heat to set the matrix, the vacuum bag and tools were removed. The resulting part was post cured free standing between 1500° F. and 2300° F., preferably 2000° F.

### EXAMPLE 2

### Alumina/Silica Ceramic Matrix

Alumina-coated Silica Sol (1056, Nalco Chemicals) containing 20% solids of colloidal silica (SiO₂) coated with alumina (Al₂O₃) in water was mixed in a blender with submicron alumina powder (SM-8, Baikowski). The mixture contained 57 wt % of alumina-coated silica sol and 43 wt % of alumina powder. Several drops of nitric acid (about 0.1%) were added to the mixture to balance the pH. The mixture was then ball milled with alumina media for 4 hours before infiltrating into the fabric. The fabric was infiltrated by the same method as described in Example 1.

### EXAMPLE 3

### Alumina/Silica Ceramic Matrix

Silica Sol (2327, Nalco Chemicals) containing 20% solids of colloidal silica (SiO₂) in water was mixed in a blender with submicron alumina powder (SM-8, Baikowski). The matrix contained 57 wt % of silica sol and 43 wt % of alumina powder. Several drops of nitric acid (about 0.1%) were added to the mixture to balance the pH. The mixture was then ball milled with alumina media for 4 hours before infiltrating into the fabric. The fabric was infiltrated by the same method as described in Example 1.

Those skilled in the art can now appreciate from the foregoing description that the broad teachings can be implemented in a variety of forms. Therefore, while the teachings have been described in connection with particular examples thereof, the true scope of the teachings should not be so limited since other modifications will become apparent to the skilled practitioner upon study of the specification, examples and following claims.

1. A method of preparing an oxide-based ceramic matrix comprising the steps of:
providing a sol-gel matrix, wherein the sol-gel matrix comprises from about 10 wt % to about 60 wt % of solids;
mixing alumina particles into the sol-gel to form a ceramic matrix wherein the alumina particles comprise from about 30 wt % to about 60 wt % of the ceramic matrix; and
if necessary, adjusting the pH to prevent gelling of the ceramic matrix.

2. The method of claim 1 wherein the sol-gel includes at least one of an alumina sol, a silica sol an alumina-coated silica sol, or combinations thereof.

3. The method of claim 1 wherein the alumina particles have a size of from about 0.1 μm to about 1.5 μm.

4. The method of claim 1 wherein adjusting the pH of the matrix includes the addition of an acid.

5. The method of claim 4 wherein the addition of the acid includes selecting at least one of a nitric acid, a hydrochloric acid, a sulfuric acid, or combinations thereof.

6. The method of claim 1 further comprising:
treating the mixture to form a homogeneous suspension.

7. The method of claim 6 wherein treating the mixture includes ball milling, attritor milling, planetory milling, high-shear mixing, or combinations thereof.

8. The method of claim 1 further comprising:
selecting a ceramic fiber.

9. The method of claim 8 wherein selecting a ceramic fiber includes selecting at least one of a continuous fiber, a cut fiber, or combinations thereof.

10. The method of claim 8 further comprising:
weaving the fiber into a fabric.

11. The method of claim 8 further comprising:
forming a composite by mixing the ceramic matrix with the ceramic fiber.

12. The method of claim 8 further comprising selecting the ceramic fiber to include at least one of quartz, silicon carbide, alumina, alumina-silicate, or combinations thereof.

13. The method of claim 8, further comprising infiltrating the ceramic matrix into the ceramic fiber.

14. A method of making a fiber-reinforced oxide based ceramic matrix composite comprising the steps of:
providing a sol-gel matrix, wherein the sol-gel matrix comprises about 10 wt % to about 60 wt % of metal oxide solids;
mixing alumina particles into the sol-gel to form a ceramic matrix wherein the alumina particles comprise about 30 wt % to about 60 wt % of the ceramic matrix;
obtaining a pH to prevent gelling of the ceramic matrix;
treating the ceramic matrix to form a homogenous suspension; and
infiltrating the homogeneous suspension into a ceramic fiber.

15. The method of claim 14 wherein the sol-gel matrix includes at least one of an alumina sol, a silica sol an alumina-coated silica sol, or combinations thereof.

16. The method of claim 14 wherein the alumina particles have a size of about 0.1 μm to about 1.5 μm.

17. The method of claim 14 which obtains a pH including adding at least one of a nitric acid, a hydrochloric acid a sulfuric acid or combinations thereof.

18. The method of claim 14, wherein obtaining a pH to prevent gelling of the ceramic matrix includes adjusting the pH by addition of at least one of an acid, a base, or combinations thereof.

19. The method of claim 14, wherein obtaining a pH to prevent gelling of the ceramic matrix includes substantially mixing the alumina particles into the sol gel.

20. The method of claim 14, wherein treating the ceramic matrix to form a homogeneous suspension includes at least one of ball milling the ceramic matrix, attritor milling the ceramic matrix, planetary milling the ceramic matrix, high shear mixing of the ceramic matrix, or combinations thereof.

21. The method of claim 14, wherein the ceramic fiber includes a ceramic fiber fabric;
wherein infiltrating the homogeneous suspension into the ceramic fiber fabric includes forming a pre-form of the infiltrated ceramic fiber fabric.

22. The method of claim 21, further comprising:
calcining the infiltrated perform; and
sintering the infiltrated preform.

23. The method of claim 14, further comprising:
calcining the infiltrated ceramic fiber;
infiltrating the ceramic fiber with the homogeneous suspension after calcining; and
repeating at least one of the calcining, the infiltrating, or combinations thereof.

24. The method of claim 14, wherein the ceramic fiber includes at least one of quartz, silicon carbide, alumina, alumina silicate, or combinations thereof.

25. A method of forming a ceramic composite comprising:
selecting a ceramic fiber;
selecting a sol gel comprising about 10 wt % to about 60 wt % of solids;
selecting an alumina particle;
mixing the alumina particle with the sol gel wherein the mixture includes about 40 wt % to about 70 wt % of the sol gel and about 30 wt % to about 60 wt % of the alumina particle; and
surrounding the selected ceramic fiber with the mixture of the sol gel and the alumina particles.

26. The method of claim 25, further comprising:
selecting a sol gel including silica sol having a solids content of about 0 wt % to about 60 wt %.

27. The method of claim 25, further comprising:
adding a filler material to the mixture.

28. The method of claim 25, wherein selecting the sol gel includes selecting an alumina sol, having a solids content up about 10 wt % to about 25 wt %.

29. The method of claim 25, wherein selecting a ceramic fiber includes forming a fabric of the selected ceramic fiber.

30. The method of claim 29, wherein the fabric of the selected fiber includes substantially continuous fibers, cut fibers, or combinations thereof.
